(19) United States
(12) Patent Application Publication
(10) Pub. No.: US 2005/0061670 A1
(43) Pub. Date: Mar. 24, 2005

(54) NOx sensing cell, manufacturing method for the NOx sensing cell, and NOx sensing device including the NOx sensing cell

(75) Inventors: Akio Tanaka, Gifu-shi (JP); Toshitaka Saito, Toyohashi-shi (JP); Tadashi Nakamura, Nagoya (JP); Tadashi Inaba, Seto-shi (JP); Keiichi Saji, Aichi-ken (JP); Jiro Sakata, Nagoya (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 10/944,426

(22) Filed: Sep. 20, 2004

(30) Foreign Application Priority Data
Sep. 18, 2003 (JP) 2003-326673

(51) Int. Cl. G01N 27/26

(52) U.S. Cl. 204/424; 204/426; 29/592.1

(57) ABSTRACT

A NOx sensing cell includes a solid electrolyte having oxide ion conductivity and a pair of electrodes electrically connected to the solid electrolyte. The measuring electrode includes an oxide portion and a noble metallic portion. The oxide portion includes the solid solution of zirconia containing at least ceria. The noble metallic portion contains at least two kinds of metallic elements selected from platinum group elements. In addition to the NOx sensing cell, a NOx sensing device includes a measuring chamber into which a sensing objective gas is introduced, and an oxygen pump cell which is capable of electrochemically removing the oxygen from the measuring chamber. The measuring electrode of the NOx sensing cell is positioned in the measuring chamber.

### BACKGROUND OF THE INVENTION

This application is based upon and claims the benefit of priority of the prior Japanese Patent Application 2003-326673 filed on Sep. 18, 2003.

The present invention relates to a NOx sensing cell (i.e. NOx sensor) including, as a base member, a solid electrolyte possessing the oxide ion conductivity. More specifically, the present invention relates to a NOx sensing device (i.e. a module) equipped with the NOx sensing cell.

An electrochemical cell includes a solid electrolyte and a pair of electrodes integrated with this solid electrolyte.

For example, the electrochemical cell can be used as a NOx sensor (i.e. NOx sensing cell) for detecting the concentration of nitrogen oxides (i.e. NOx) contained in a gas to be measured (hereinafter, referred to as “sensing objective gas”).

The Japanese Patent Application Laid-open No. 2001-318075, corresponding to the U.S. patent application Publication 2001/0023823, discloses a NOx gas sensing device equipped with a cathode containing an alloy having a specific composition.

The Japanese Patent Application Laid-open No. 2000-292405 or the Japanese Patent Application Laid-open No. 5-249070 (1993) discloses an oxygen sensor including an electrochemical cell that can detect the oxygen concentration in a sensing objective gas.

According to a NOx sensor including an electrochemical cell, a voltage is applied between the electrodes to decompose the NOx components contained in the sensing objective gas on the measuring electrode (i.e. cathode). The oxygen components, when decomposed, can move as oxide ions (O²⁻) across the solid electrolyte toward the reference electrode (i.e. anode). Then, the oxide ion returns to the oxygen at the reference electrode. This is generally referred to as the oxygen pumping function. A current value flowing between the electrodes represents the NOx concentration. Accordingly, the measuring electrode for the NOx sensor should have excellent decomposing activity for decomposing the NOx components.

### SUMMARY OF THE INVENTION

In view of the foregoing, the present invention has an object to provide a NOx sensing cell (i.e. a NOx sensor) which is equipped with a measuring electrode (i.e. cathode) having excellent NOx decomposing activity.

The present invention has another object to provide a NOx sensing device including the NOx sensing cell equipped with the measuring electrode (i.e. cathode) having excellent NOx decomposing activity.

Furthermore, the invention has another object to provide a method for manufacturing the NOx sensing cell equipped with the measuring electrode (i.e. cathode) having excellent NOx decomposing activity, or a method for manufacturing the NOx sensing device including the NOx sensing cell equipped with the measuring electrode (i.e. cathode) having excellent NOx decomposing activity.

In order to accomplish the above and other related objects, the inventions of this application propose to use a measuring electrode which contains an oxide (solid solution) of zirconia containing at least ceria.

The NOx sensing cell according to the present invention includes a solid electrolyte having oxide ion conductivity, and a pair of electrodes electrically connected to this solid electrolyte. A measuring electrode, serving as one of two electrodes of the NOx sensing cell, includes an oxide portion and a noble metallic portion. The oxide portion includes the solid solution of zirconia containing at least ceria. And, the noble metallic portion contains at least two kinds of metallic elements selected from platinum group elements.

The oxide (solid solution) of zirconia containing at least ceria (which is referred to as “zirconia-ceria solid solution” hereinafter) has the chemical tendency of being easily reduced, when it is compared with the solid solution of zirconia containing no ceria.

According to the NOx sensing cell according to the present invention, the measuring electrode is brought into a deficiency-of-oxygen condition in response to application of a voltage. The deficiency of oxygen occurs on an interfacial region between the ceramic component (including the zirconia-ceria solid solution) and the metallic component of the measuring electrode. The deficiency-of-oxygen condition can smoothly advance the NOx decomposing action. Namely, the oxygen (O) resulting from the NOx decomposition easily diffuses from the noble metallic portion toward the interface of the solid electrolyte via the oxide portion and easily ionizes into an anion. Accordingly, the NOx sensing cell including the above-described measuring electrode can show excellent performances (e.g. high sensitivity and/or quick response).

According to a preferable embodiment of the NOx sensing cell according to this invention, the measuring electrode of the sensing cell contains Pt (i.e. platinum) as a metallic element. Furthermore, the measuring electrode of the sensing cell has a noble metallic portion including at least one of Pd (i.e. palladium) and Rh (i.e. rhodium).

The measuring electrode including this kind of noble metallic portion has excellent NOx decomposing activity. Accordingly, the NOx sensing cell including this measuring electrode can assure excellent sensor performances.

According to a preferable embodiment of the NOx sensing cell according to this invention, the measuring electrode of the oxide portion consists of zirconium (Zr) and cerium (Ce). The atomic ratio of Zr and Ce contained in the oxide portion satisfies the condition Ce/Zr≦0.5. The NOx sensing cell including this measuring electrode can demonstrate excellent measuring accuracy in measuring the NOx concentration.

According to a preferable embodiment of the NOx sensing cell according to this invention, the measuring electrode contains the oxide portion by 0.5 to 20 mass %. In other words, the zirconia-ceria solid solution occupies 0.5 to 20%, by mass, in the entire measuring electrode. This setting is advantageous in that the NOx decomposing activity and the electric conductivity of the measuring electrode can be highly balanced.

Furthermore, the inventors of this application propose a NOx sensing device including a measuring chamber into which a gas to be measured is introduced, and a NOx sensing cell for detecting the concentration of NOx contained in the gas introduced in the measuring chamber. This NOx sensing device can use any one of the NOx sensing cells disclosed in this specification. The NOx sensing device further includes an oxygen pump cell for electrochemically removing the oxygen out of the measuring chamber. The oxygen pump cell includes a solid electrolyte for conducting the oxygen from the measuring chamber to the outside of the measuring chamber, and a pair of electrodes electrically integrated with this solid electrolyte.

According to this NOx sensing device, due to the oxygen pumping function of the oxygen pump cell, the oxygen contained in the sensing objective gas (typically, oxygen gas (O2)) can be smoothly discharged out of the measuring chamber. The sensing accuracy for measuring the NOx concentration in the sensing objective gas can be improved.

According to a preferable embodiment of the NOx sensing cell of this invention, at least one electrode of the oxygen pump cell contains gold (Au). The NOx sensing device including this oxygen pump cell has excellent sensing accuracy for detecting the concentration of NOx.

On the other hand, according to this kind of NOx sensing device, when it is manufactured (typically, in the sintering process) or when it is used in high-temperature environments, the gold (Au) constituting the oxygen pump cell may scatter and adhere on the measuring electrode of the NOx sensing cell. In general, the NOx decomposing activity is worsened when the gold (Au) adheres on the measuring electrode of the NOx sensing cell.

In this respect, the NOx sensing cell (or the measuring electrode) according to the present invention can assure excellent NOx decomposing activity. Therefore, the NOx sensing device of this invention has excellent performance.

Furthermore, the inventors of this application propose a first method for manufacturing a NOx sensing cell, including a step of preparing a measuring electrode forming composition including an oxide ceramic forming component containing Zr and Ce and a noble metallic component containing at least two kinds of metallic elements selected from platinum group elements. The first manufacturing method further includes a step of putting the measuring electrode forming composition on a surface of a ceramic molded body. The ceramic molded body, when it is sintered, forms a solid electrolyte having oxide ion conductivity. And, the first manufacturing method further includes a step of sintering the ceramic molded body together with the measuring electrode forming composition in the temperature range from 1200° C. to 1700° C. The first manufacturing method is preferably applicable to any one of the NOx sensing cells disclosed in this application.

Furthermore, the inventors of this application propose a second method for manufacturing a NOx sensing cell, including a step of preparing a measuring electrode forming composition including an oxide ceramic forming component containing Zr and Ce and a noble metallic component containing at least two kinds of metallic elements selected from platinum group elements. The second manufacturing method further includes a step of putting the measuring electrode forming composition on a surface of an oxide ion conductive solid electrolyte having a predetermined shape. And, the second manufacturing method further includes a step of sintering the oxide ion conductive solid electrolyte together with the measuring electrode forming composition in the temperature range from 1200° C. to 1700° C. The second manufacturing method is preferably applicable to any one of the NOx sensing cells disclosed in this application.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view explaining a method for sintering a sample in the process of manufacturing a NOx sensing cell in accordance with a preferred embodiment of the present invention;

FIG. 2 is a cross-sectional view schematically showing the arrangement of a model cell used for the evaluation of the NOx sensing cell in accordance with preferred embodiment of the present invention;

FIG. 3A is a graph showing the current-voltage characteristics measured with respect to a model cell of sample 1;

FIG. 3B is a graph showing the current-voltage characteristics measured with respect to a model cell of sample 2;

FIG. 4A is a graph showing the current-voltage characteristics measured with respect to a model cell of sample 3;

FIG. 4B is a graph showing the current-voltage characteristics measured with respect to a model cell of sample 4;

FIG. 5A is a graph showing the current-voltage characteristics measured with respect to a model cell of sample 5;

FIG. 5B is a graph showing the current-voltage characteristics measured with respect to a model cell of sample 6;

FIG. 6 is a graph showing the current-voltage characteristics measured with respect to a model cell of sample 7;

FIG. 7 is a photographic view taken by a scanning electron microscope which shows an electrode manufactured by using the composition of sample 5;

FIG. 8 is a photographic view taken by a scanning electron microscope which shows an electrode manufactured by using the composition of sample 6;

FIG. 9 is a chart showing x-ray diffraction patterns of the electrodes manufactured by using the compositions of samples 5 and 6;

FIG. 10 is a graph showing the current-voltage characteristics measured with respect to a model cell of sample 8-1;

FIG. 11 is a graph showing the current-voltage characteristics measured with respect to a model cell of sample 8-2;

FIG. 12 is a graph showing the current-voltage characteristics measured with respect to a model cell of sample 9-1;

FIG. 13 is a graph showing the current-voltage characteristics measured with respect to a model cell of sample 9-2;

FIG. 14 is a graph showing the current-voltage characteristics measured with respect to a model cell of sample 10;

FIG. 15 is a graph showing the relationship between the cerium oxide amount and the ratio of current values at the voltages 0.75V and 0.35V; and

FIG. 16 is a cross-sectional view schematically showing the arrangement of a preferable NOx sensing device in accordance with the present invention.

### DESCRIPTION OF THE PREFERRED EMBODIMENT

Hereinafter, a preferred embodiment of the present invention will be explained. The present invention can be put into practice based on the disclosure of this specification as well as general knowledge in the related technical fields. For example, the design of a reference electrode of a NOx sensing cell will be necessary in practically embodying this invention and can be carried out based on a conventional technique.

A solid electrolyte, corresponding to a base member of the NOx sensing cell of the present invention, should have appropriate oxide ion conductivity. However, the solid electrolyte of this invention is not limited to a specific material or member. For example, a preferable example of the solid electrolyte used in this invention is a zirconia-based solid electrolyte (especially, ZrO₂-M₂O₃ solid solution or ZrO₂-MO solid solution, wherein “M” in these formulas is preferably selected from the group consisting of Y, Yb, Gd, Ca, and Mg), or a ceria-based solid electrolyte (especially, CeO₂-M₂O₃ solid solution or CeO₂-M solid solution, wherein “M” in these formulas is preferably selected between Y and Sm), or a bismuth oxide-based solid electrolyte (especially, BiO₃—WO₃ solid solution), or a LaGaO3-based compound having a perovskite structure.

An exhaust gas of an internal combustion engine installed in an automotive vehicle is a sensing objective gas of this invention. Considering the stability and oxide ion conductivity, the zirconia-based solid electrolyte is a preferable solid electrolyte for the present invention. More specifically, the solid solution of stabilized zirconia containing 3-10 mol % yttria, magnesia, or calcia is preferable.

The NOx sensing cell has a pair of (or two or more pairs of) electrodes. One of the measuring electrodes is a so-called cermet electrode having a noble metallic portion and an oxide portion. The noble metallic portion contains at least two kinds of metallic elements selected from the platinum group elements. A preferred combination of the metallic elements includes at least one kind of element selected from the group consisting of platinum (Pt), palladium (Pd), and rhodium (Rh) and at least one kind of other platinum group elements.

In view of the NOx decomposing activity, it is preferable to use an alloy containing at least one of Pt, Pd, and Rh, such as a Pt—Pd alloy, a Pt—Rh alloy, and a Pt—Pd—Rh alloy. Furthermore, in order to obtain a NOx sensing cell having a clear limiting current region, it is preferable to use an alloy containing both of Pt and Rh, such as a Pt—Rh alloy, and a Pt—Pd—Rh alloy. It is preferable that the noble metallic portion contains, by mass, 40% or more (preferably 50% or more) Pt. It is preferable that these metallic components constitute an alloy (more specifically, an alloy chiefly containing Pt). Furthermore, the noble metallic portion can contain any impurity component (e.g. Au) other than the above-described metallic components, when this impurity component gives no adverse effect to the measuring electrode of the NOx sensing cell.

The ceramic component constituting the measuring electrode includes the zirconia-ceria solid solution that is a solid solution of zirconia containing at least ceria. The zirconia-ceria solid solution can further contain one kind (or two or more kinds) of metal oxide other than ceria (e.g. yttria, magnesia, calcia etc.). For example, a preferable zirconia-ceria solid solution includes the stabilized zirconia which contains, by mol, approximately 3 to 10% yttria, magnesia, or calcia, in addition to ceria. A preferable solid solution amount of ceria relative to zirconia is equal to or less than 0.5 in the atomic ratio of cerium to zirconium (i.e. Ce/Zr). For example, it is preferable to use a zirconia-ceria solid solution in the range of 0.05 to 0.5 (more preferably, in the range of 0.1 to 0.3) in the atomic ratio of Ce/Zr. 25 When the atomic ratio of Ce/Zr is greater than the above range, the NOx sensing accuracy is not good. When the atomic ratio of Ce/Zr is in the above range, the effect of using the zirconia-ceria solid solution (more specifically, the effect of improving the NOx decomposing activity) and the NOx sensing accuracy can be nicely balanced.

The atomic ratio of cerium to zirconium contained in the zirconia-ceria solid solution can be detected, for example, based on a peak position of an x-ray diffraction pattern.

It is possible to entirely form the ceramic component contained in the measuring electrode of the NOx sensing cell by the zirconia-ceria solid solution. This ceramic component can contain a component other than the above-described zirconia-ceria solid solution (e.g. an oxide having a composition similar to that of the above-described solid electrolyte corresponding to the base member of the NOx sensing cell). It is preferable that the ceramic component occupies, by mass, approximately 3 to 30% (more preferably, approximately 5 to 20%) of the entire measuring electrode. When the content of the ceramic component is less than the above range, the adherence of the measuring electrode against the base member (i.e. solid electrolyte) will be insufficient. On the other hand, when the content of the ceramic component is greater than the above range, the electric conductivity of the measuring electrode will be not good. Furthermore, it is preferable that the content of the zirconia-ceria solid solution relative to the entire measuring electrode is in the range of, for example, 0.1 to 30 mass %. A more preferable range is 0.5 to 20 mass %, and a further preferable range is 3 to 15 mass %.

On the other hand, the reference electrode (i.e. anode) of the NOx sensing cell is not limited to a specific arrangement. In view of the adherence against the base member (i.e. the solid electrolyte), it is preferable to use a cermet electrode containing a metallic portion and a ceramic portion. The material for forming the metallic portion should be stable even if it is subjected to high-temperature and high-humidity environments, like an exhaust gas of an engine.

For example, a preferable metallic portion is a metal having a higher melting point, such as a noble metal (more specifically, Pt, Pd, or Rh) belonging to the platinum group elements, or other noble metal (more specifically, Au or Ag), or a base metal having high electric conductivity (e.g. Ni). Furthermore, another preferable metallic portion is an alloy based on any one of these metals (e.g. Pt—Rh, Pt—Ir, etc).

Furthermore, a preferable material for forming the ceramic portion is an oxide having the composition similar to that of the solid electrolyte corresponding to the base member. To assure the adherence and the electric conductivity against the base member, it is preferable that the ratio of the ceramic portion relative to the entire reference electrode is in the range of 3 to 30 mass %, more preferably in the range of 5 to 20 mass %.

The solid electrolyte of the NOx sensing cell or the NOx sensing device according to the present invention can be manufactured by a method conventionally known in this technical field.

For example, one of plural kinds of powdered compounds containing metallic atoms constituting an objective solid electrolyte are mixed with an appropriate binder, solvent, and the like to form a composition for forming the solid electrolyte. The above powdered compounds are oxides containing the required metallic atoms or the compound turning into the oxides when they are heated. The composition for forming the solid electrolyte is configured into a ceramic molded body having a shape corresponding to an objective solid electrolyte. As a molding method, it is possible to use the extrusion molding method, or the press molding method. The ceramic molded body is sintered in an oxidizing atmosphere (e.g. in the air) or in an inert gas atmosphere to obtain a solid electrolyte having a predetermined shape (for example, a plate 10 shown in FIG. 2). A proper sintering temperature, although dependent on the composition of the ceramic, is in the range of 1200° C. to 1700° C. (preferably in the range of 1400° C. to 1600° C.). In the case of a zirconia-based solid electrolyte, it is preferable to perform the sintering operation at 1400° C. or above.

The electrode of the NOx sensing cell can be manufactured by any method conventionally known for forming the electrode.

For example, one or plural kinds of powdered metals (or powered alloys) corresponding in composition to a noble metallic portion constituting the objective measuring electrode are prepared. Meanwhile, one or plural kinds of powdered compounds of the metal oxides (or the oxides turning into the metal oxides when heated) corresponding in composition to the ceramic component of the objective measuring electrode are prepared. Then, the powdered metals (or powered alloys) and the powdered compounds of the metal oxides diffuse into an appropriate organic medium (i.e. vehicle) to obtain a measuring electrode forming composition in a paste (or ink) condition.

Next, the measuring electrode forming composition is put on a surface of the solid electrolyte (e.g. yttria stabilized zirconia). For example, the composition having a predetermined size and a predetermined thickness is coated on the solid electrolyte based on the screen printing method or the like. Then, the solid electrolyte with the composition coated on its surface is sintered at an appropriate sintering temperature (e.g. in the range of 800 to 1600° C.), to obtain a baked measuring electrode having a predetermined shape and a predetermined thickness. Alternatively, it is possible to put a measuring electrode forming composition on the surface of the above ceramic molded body (i.e. the solid electrolyte having not been sintered yet). This composition and the ceramic molded body are sintered together to simultaneously form a baked solid electrolyte and a baked measuring electrode. In this case, it is desirable to adjust the sintering temperature according to the composition of the solid electrolyte (i.e. ceramic composition). Regarding the zirconia-ceria solid solution contained in the measuring electrode of the NOx sensing cell, it can be produced in the process of sintering the measuring electrode forming composition. It is also possible to use the raw powder of the zirconia-ceria solid solution to form a measuring electrode forming composition which is then sintered to obtain the measuring electrode.

The above-described manufacturing method for forming the measuring electrode can be equally applied to form the reference electrode of the NOx sensing cell.

In the case of sintering the measuring electrode forming composition to form a measuring electrode including a noble metallic portion chiefly containing the platinum group element, the metallic components tend to aggregate on an obtained cathode when the sintering temperature is relatively high (e.g. at 1400° C. or above), as shown in FIG. 7. The aggregation of the metallic components is disadvantageous in that a contact area (i.e. interface) of the measuring electrode relative to the solid electrolyte becomes small. It will be difficult to assure satisfactory NOx decomposing properties. In such a case, after the electrode is formed (baked) on the surface of the solid electrolyte, it will be effective to perform a predetermined post-treatment to restore the original NOx decomposing properties.

For example, a high voltage is applied to the NOx sensing cell. A large current flows in the NOx sensing cell. The solid electrolyte is once brought into a chemically reduced condition in the vicinity of the metallic component. Thereafter, the oxidation treatment is again performed. This treatment, hereinafter referred to as “current supply activating treatment”, is effective in improving the contact condition between the metallic component and the solid electrolyte, so that the oxygen produced through the decomposition of NOx can be smoothly ionized and accordingly the NOx decomposing process can advance adequately.

The measuring electrode of the NOx sensing cell according to the present invention includes an oxide portion (i.e. zirconia-ceria solid solution) which consists of zirconia and ceria. The interfacial region between this oxide portion (i.e. zirconia-ceria solid solution) and the metallic portion tends to lack the oxygen. Accordingly, without performing the current supply activating treatment, the present invention can realize a condition similar to the interfacial region between the metallic component and the solid electrolyte which is to be obtained by executing the above-described current supply activating treatment (current supply aging).

Namely, even when the NOx sensing cell according to the present invention is sintered at a relatively high temperature (e.g. 1400° C. and above) to form a measuring electrode, it is possible to assure excellent NOx decomposing properties without performing the current supply activating treatment. It is however possible to additionally perform the current supply activating treatment.

The NOx sensing cell of the present invention is preferably used as an essential constituent element of the NOx sensing device equipped with an oxygen pump cell which removes the oxygen from the sensing objective gas. The oxygen pump cell generally consists of a solid electrolyte and a pair of (or two pairs) of electrodes. When a predetermined voltage is applied between these electrodes, the oxygen is discharged from the cathode to the anode due to the oxygen pumping function. In the NOx sensing device, it is desirable that the oxygen pump cell and the NOx sensing cell should be electrically insulated. The oxygen pump cell, serving as a cathode, should have excellent O₂ decomposing activity and have relatively low NOx decomposing activity. In other words, the oxygen pump cell is required to possess the capability of selectively discharging the O₂ gas. To this end, a cathode made of a material containing Pt and Au is a preferable oxygen pump cell. For example, an alloy chiefly containing Pt and Au is preferably used for the cathode. In addition to such metallic components, the cathode of the oxygen pump cell may contain a ceramic component if its content is not so much that the electric conductivity is worsened. Furthermore, the anode of the oxygen pump cell can be made of a material similar to that of the reference electrode (i.e. anode) of the above-described NOx cell. The solid electrolyte, the cathode, and the anode of the oxygen pump cell can be manufactured by substantially the same method for manufacturing the solid electrolyte, the measuring electrode, and the reference electrode of the NOx sensing cell.

Hereinafter, a preferred embodiment of the NOx sensing device (i.e. NOx sensing module) will be explained with reference to the attached drawings.

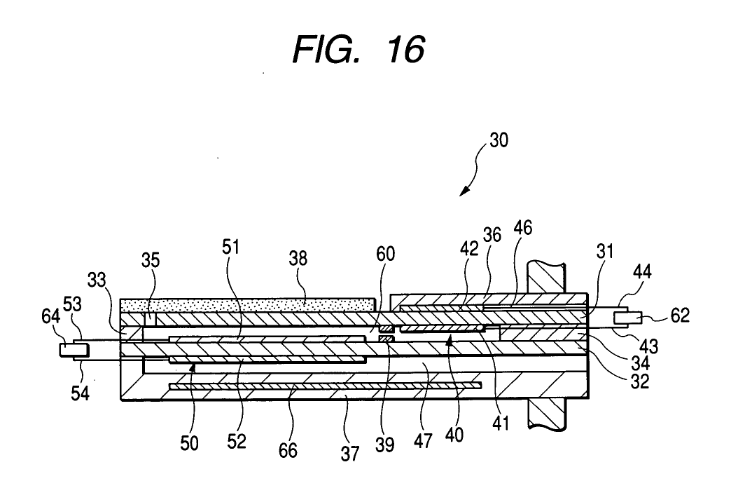

FIG. 16 shows a NOx sensing device 30 having a NOx sensing cell 40, an oxygen pump cell 50, and a measuring chamber 60. The NOx sensing device 30 includes solid electrolytes 31 and 32 made of stabilized zirconia or the like and partition walls 33 and 34 interposing between these solid electrolytes 31 and 32. The solid electrolytes 31 and 32 and the partition walls 33 and 34, made of gas-impermeable materials and cooperatively define a measuring chamber 60, prevent the gas from feely going out of the device 30 or entering from the outside.

The NOx sensing cell 40 is located at a predetermined portion of the solid electrolyte 31. More specifically, an electrode (i.e. measuring electrode) 41 possessing excellent NOx decomposing activity is formed on an inner surface of the solid electrolyte 31 so that this electrode 41 is positioned in the measuring chamber 60. The measuring electrode 41, as described above, includes a zirconia-ceria solid solution portion and a noble metallic portion containing two or more kinds of platinum group elements. Furthermore, another electrode (i.e. reference electrode) 42 is positioned on an outer surface of the solid electrolyte 31 (i.e. on a surface positioned far from the measuring chamber 60). The reference electrode 42 is chiefly made of, for example, platinum. These electrodes 41 and 42 are connected to an external power source 62 via lead lines 43 and 44. A predetermined voltage is applied between two electrodes 41 and 42 via the lead lines 43 and 44. Furthermore, an ammeter (not shown) is connected to the lead line 43 or 44 to measure the current flowing between the electrodes 41 and 42.

Furthermore, a partition wall 36 made of a gas-impermeable material is provided on an outer surface of the solid electrolyte 31 so as to cover a predetermined region including the reference electrode 42. The partition wall 36 and the solid electrolyte 31 cooperatively define a gas flow passage 46 extending between them in the longitudinal direction. One end of the gas flow passage 46 is opened to the outside (e.g., to the atmospheric environment).

A through-hole 35 (hereinafter, referred to as “gas introducing hole”) is opened at a predetermined position of the solid electrolyte 31 with a sufficient distance from the sub chamber where the NOx sensing cell 40 is provided. The gas introducing hole 35 has a function of introducing a sensing objective gas into the measuring chamber 60. To this end, the gas introducing hole 35 has a size capable of controlling the flow (or diffusion) of the sensing objective gas introduced into the measuring chamber 60. As shown in the drawing, a diffusion control layer 38 is provided on the outer surface of the solid electrolyte 31. The diffusion control layer 38, made of a porous material (e.g. porous alumina), covers the outlet port of gas introducing hole 35. With this arrangement, the sensing objective gas can be introduced into the measuring chamber 60 with a controlled (or stabilized) flow and/or diffusion velocity.

The oxygen pump cell 50 is located at a predetermined portion of the solid electrolyte 32. More specifically, an electrode (i.e. cathode) 51 is formed on an inner surface of the solid electrolyte 32 and is positioned in the measuring chamber 60. The electrode 51 is made of a material made possessing excellent O₂ decomposing activity and low NOx decomposing activity. For example, the electrode 51 chiefly contains a Pt—Au alloy. Furthermore, another electrode (i.e. anode) 52 is positioned on an outer surface of the solid electrolyte 32 (i.e. on a surface positioned far from the measuring chamber 60). The electrode 52 is chiefly made of, for example, platinum.

As shown in the drawing, these electrodes 51 and 52 are connected to an external power source 64 via lead lines 53 and 54. A predetermined voltage is applied between the electrodes 51 and 52 via the lead lines 53 and 54. With this arrangement, the oxygen can be discharged from the measuring chamber 60 to the outside.

A partition wall 39, provided in the measuring chamber 60, separates a sub chamber where the oxygen pump cell 50 is formed and a sub chamber where the NOx sensing cell 40 is formed. The partition wall 39 is made of a gas-impermeable material and has a small hole. The partition wall 39 has a function of adjusting (stabilizing) the velocity of the sensing objective gas flowing and/or diffusing between two regions.

As shown in FIG. 16, the gas introducing hole 35 is positioned in the sub chamber of the oxygen pump cell 50 and is opened to an end position far from the sub chamber of the NOx sensing cell 40. According to this arrangement, the sensing objective gas flows into the measuring chamber 60 via the gas introducing hole 35 and reaches the NOx sensing cell 40. In this flowing/diffusing process, the oxygen contained in the sensing objective gas can be effectively removed (reduced) by the oxygen pump cell 50.

A partition wall 37, made of a gas-impermeable material, is provided on an outer surface of the solid electrolyte 32 so as to cover a predetermined range including the electrode 52. The partition wall 37 and the solid electrolyte 32 cooperatively define a gas flow passage 47. One end of the gas flow passage 47 is opened to the outside (e.g., to the atmospheric environment). The partition wall 37 is equipped with a heater 66. The heater 66, when it is activated, heats the entire or partial region of the device 30 (e.g. the NOx sensing cell 40 and the oxygen pump cell 50) up to a predetermined temperature range.

Furthermore, it is preferable the material constituting the above-described partition walls 33, 34, 36, 37, and 39 has sufficient insulating and heat-resistance properties in the temperature range in which this NOx sensing device is used. For example, the ceramic material, such as alumina, spinel, mullite, and cordierite, can be preferable used.

The NOx sensing device 30 can be used in a condition that the sensing objective gas can reach and enter into the gas introducing hole 35. More specifically, as shown in FIG. 16, the entire body of the device 30 is exposed to the sensing objective gas. For example, the sensing objective gas is an exhaust gas of an internal combustion engine of an automotive vehicle. When the heater 66 is activated, the device 30 is heated up to an appropriate temperature range (e.g. approximately 700° C.). The sensing objective gas can diffuse in the diffusion control layer 38 and reach the gas introducing hole 35 and then flows into the measuring chamber 60 (i.e. the sub chamber where the oxygen pump cell 50 is formed). When a voltage is applied between the electrodes 51 and 52 of the oxygen pump cell 50, the oxygen pump cell 50 removes the oxygen contained in the sensing objective gas out of the measuring chamber 60. The removed oxygen gas can exit to the outside via the gas flow passage 47. The sensing objective gas, after it is introduced into the measuring chamber 60, flows (diffuses) into the sub chamber of the NOx sensing cell 40 via the small hole of the partition wall 39. The oxygen concentration of the sensing objective gas can be adequately adjusted in this flowing/diffusing process.

When a predetermined voltage is applied between the electrodes 41 and 42 of the NOx sensing cell 40, it is possible to detect the NOx concentration of the sensing objective gas having reached the NOx sensing cell 40.

More specifically, the measuring electrode 41 adsorbs NOx contained in the sensing objective gas. In this measuring electrode 41, NOx decomposes at the noble metallic portion (containing two or more kinds of platinum group elements). As a result of NOx decomposition, the oxygen is produced and temporarily adsorbed in the metallic portion. The oxygen diffuses in the interfacial region between the metallic portion and the solid electrolyte 31. The oxygen is ionized in this interfacial region into an oxide ion (O²⁻). The produced oxide ion is discharged toward the electrode (reference electrode) 42 of the solid electrolyte 31, with the current flowing between the electrodes 41 and 42. Thus, the NOx concentration is detectable by measuring this current with an ammeter (not shown).

The oxygen gas concentration (the degree of removed oxygen gas) in the sensing objective gas reaching the NOx sensing cell 40 can be adjusted by controlling the voltage applied to the oxygen pump cell 50. For example, it is preferable to control the applied voltage in such a manner that the oxygen gas concentration becomes equal to or less than 10 ppm. Accordingly, when the sensing objective gas entering via the gas introducing hole 35 contains no oxygen gas or has a relatively low oxygen gas concentration, it is possible to use the device 30 without applying any voltage to the oxygen pump cell 50 (i.e. without relying on the oxygen pumping function). Furthermore, according to the above-described NOx sensing device, it is possible to add an oxygen supplying device for supplying the oxygen into the measuring chamber 60. For example, it is possible to provide an oxygen pump cell (serving as an oxygen supplying cell) having a solid electrolyte and a pair of electrodes which can electrochemically supply the oxygen from the outside into the measuring chamber when a voltage is applied between the electrodes.

The NOx sensing cell disclosed in this specification can be preferably manufactured in the following manner.

A first method for manufacturing the NOx sensing cell, includes:
a step of preparing a measuring electrode forming composition including an oxide ceramic forming component containing Zr and Ce and a noble metallic component containing at least two kinds of metallic elements selected from platinum group elements;
a step of putting the measuring electrode forming composition on a surface of a ceramic molded body, the ceramic molded body forming a solid electrolyte having oxide ion conductivity when the ceramic molded body is sintered; and
a step of sintering the ceramic molded body together with the measuring electrode forming composition in the temperature range from 1200° C. to 1700° C. (preferably, in the range from 1400° C. to 1600° C.).

The NOx sensing cell manufactured according to this first method can show excellent NOx decomposing properties and can be used without performing the above-described current supply activating treatment (i.e. current supply aging).

A second method for manufacturing the NOx sensing cell, includes:
a step of preparing a measuring electrode forming composition including an oxide ceramic forming component containing Zr and Ce and a noble metallic component containing at least two kinds of metallic elements selected from platinum group elements;
a step of putting the measuring electrode forming composition on a surface of an oxide ion conductive solid electrolyte having a predetermined shape; and
a step of sintering the oxide ion conductive solid electrolyte together with the measuring electrode forming composition in the temperature range from 1200° C. to 1700° C. (preferably, in the range from 1400° C. to 1600° C.).

The NOx sensing cell manufactured according to this second method can show excellent NOx decomposing properties and can be used without performing the above-described current supply activating treatment (i.e. current supply aging) applied to the sintered measuring electrode (i.e. cermet electrode).

Preferably, the measuring electrode forming composition used in the above-described first or second method contains Pt and other platinum group elements by 80 to 99.5 mass part in total, a stabilized zirconia (e.g., the solid solution of stabilized zirconia including 3 to 10 mol % yttria, magnesia, or calcia) by 0.5 to 20 mass part, and a compound (e.g. oxide) chiefly containing cerium as a main metallic element by 0.1 to 10 mass part.

The above-described NOx sensing cell manufacturing method can serve as a part of the manufacturing method for a NOx sensing device including this sensing cell.

The present invention relates to a method for manufacturing a NOx sensing device having a measuring chamber into which the sensing objective gas is introduced, a NOx sensing cell for detecting the NOx concentration in the sensing objective gas introduced into the measuring chamber, and an oxygen pump cell. The NOx sensing cell disclosed in this specification can be used as the NOx sensing cell of this NOx sensing device. The oxygen pump cell of this NOx sensing device, having a function of electrochemically removing the oxygen from the measuring chamber, includes a solid electrolyte for conducting the oxygen from the measuring chamber to the outside and a pair of electrodes electrically connected to this solid electrolyte.

Thus, the present invention provides a NOx sensing device manufacturing method characterized in that the NOx sensing cell is formed by the manufacturing steps of the above-described first or second method.

Furthermore, a preferable NOx sensing cell according to the present invention has the following characteristics.

(i) The measuring electrode of the NOx sensing cell has an oxide portion including the solid solution of zirconia containing at least ceria and a noble metallic portion containing Pt and at least one of Pd and Rh.

(ii) The noble metallic portion contains Pt by 50 to 80 mass % (preferably 55 to 65 mass %), and at least one kind of other platinum group element by 20 to 50 mass % (preferably 35 to 45 mass %).

(iii) Preferably, the platinum group elements other than Pt are Rh and/or Pd.

(iv) Preferably, the noble metallic portion contains Rh and Pd by the mass ratio of approximately 10:0 to 2:8.

### Manufacturing of NOx Sensing Cell to be Tested

The inventors of this application have prepared samples 1 to 7 of the measuring electrode forming composition having the composition show in table 1.

In preparing these samples of the composition, the inventors have mixed the powders of platinum (Pt), rhodium (Rh), palladium (Pd), yttria stabilized zirconia (ZrO₂-8 mol % Y₂O₃, hereinafter, referred to as “YSZ”), and the oxide powder expressed by the formula Ce_{0.8}Gd_{0.2}O₂ (hereinafter, referred to as “cerium oxide”) at a predetermined ratio.

The samples 2, 4, and 6 for the measuring electrode forming composition are equivalent to the samples 1, 3, and 5 respectively, except for addition of the cerium oxide. More specifically, 0.05 g cerium oxide is added to the base material (i.e. a portion remaining when the organic component is removed from the composition) of 1 g.

Furthermore, the samples 1 to 6 for the measuring electrode forming composition contain two or three kinds or platinum group elements. On the other hand, the sample 7 contains only one kind of platinum group element (Pt).

Meanwhile, the inventors have prepared a reference electrode having the composition shown in table 1 by using the same Pt powder and the YSZ powder which are used for preparing the above-described samples of the measuring electrode forming composition.

The compositions shown in table 1 include no organic components.

TABLE 1

| | Measuring electrode composition | | Reference |
|---|---|---|---|
| Sample | | Cerium | electrode |
| No. | Base material | oxide*1 | composition |
| 1 | Pt-36% Rh-10% YSZ | 0 | Pt-10% YSZ |
| 2 | Pt-36% Rh-10% YSZ | 0.05 | Pt-10% YSZ |
| 3 | Pt-36% Pd-10% YSZ | 0 | Pt-10% YSZ |
| 4 | Pt-36% Pd-10% YSZ | 0.05 | Pt-10% YSZ |
| 5 | Pt-25.2% Pd-10.8% Rh-10% YSZ | 0 | Pt-10% YSZ |
| 6 | Pt-25.2% Pd-10.8% Rh-10% YSZ | 0.05 | Pt-10% YSZ |
| 7 | Pt-10% YSZ | 0.05 | Pt-10% YSZ |

*1cerium oxide amount (g) added to the base material of 1 g

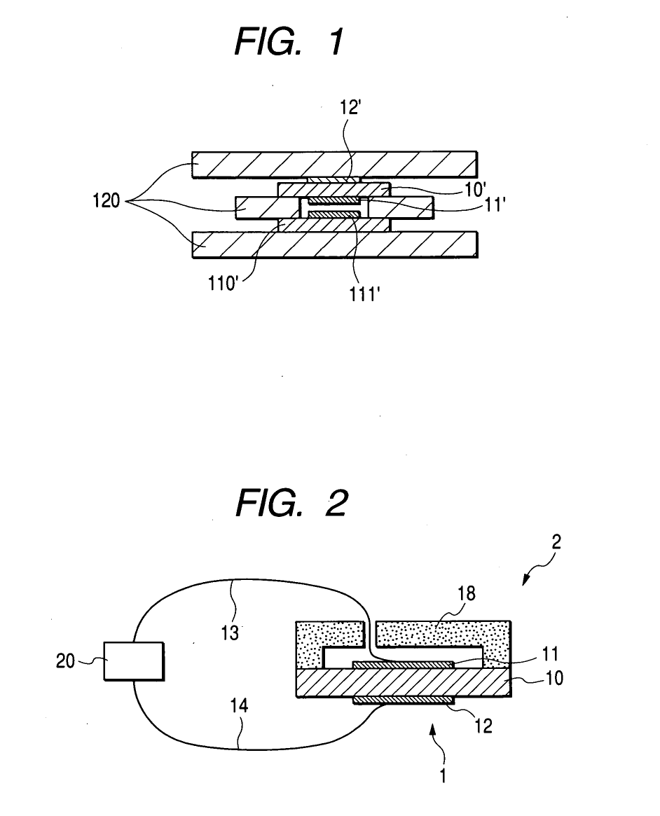

As shown in FIG. 1, the measuring electrode forming composition 11′ and the reference electrode forming composition 12′ are printed on opposed surfaces of a disk-shaped YSZ (ZrO₂-8 mol % Y₂O₃) green sheet (ceramic molded body) 10′ by screen printing method.

On the other hand, to simulate a condition of the above assembled green sheet together with an oxygen pump cell having a gold (Au) containing electrode, the inventors have prepared another YSZ green sheet 110′ with an Au-containing composition 111′ printed on its surface by screen printing in addition to the YSZ green sheet 10′ used for manufacturing the NOx sensing cell. This Au-containing composition is a composition (Pt-2% Au-10% YSZ) containing Pt, 2 mass % Au, and 10 mass % YSZ. Then, by using alumina plates 120 as sintering jigs, the inventors have set the green sheet 110′ in such a manner that the Au-containing composition 111′ and the measuring electrode forming composition 11′ are opposed to each other. The gap between the Au-containing composition 11′ and the measuring electrode forming composition 11′ is approximately 1 mm. Then, the inventors have sintered this assembly in the air at 1480° C. (i.e. under the conditions that Au can evaporate and scatter) for one hour.

FIG. 2 shows a NOx sensing cell 1 having been thus obtained which has a measuring electrode 11 formed on one surface of the solid electrolyte (YSZ) 10 and a reference electrode 12 formed on the other surface of the solid electrolyte (YSZ) 10. The NOx sensing cell 1 has the diameter of approximately 17 mm. Furthermore the measuring electrode 11 and the reference electrode 12 are the same circular electrodes that have the diameter of approximately 8 mm.

### Evaluation of NOx Sensing Cell

The inventors have evaluated the performance of the NOx sensing cells using the samples 1 to 7 which are manufactured by the above-described method.

As shown in FIG. 2, the Au lead lines 13 and 14 are connected to the measuring electrode and the reference electrode 12 of the NOx sensing cell 11 by the thermo-compression bonding method. Furthermore, the measuring electrode 11 is covered with a diffusion control member 18. The diffusion control member 18 has an average pore diameter of approximately 0.4 mm and is made of porous alumina. Thus, a model cell 2 is constructed for performance evaluation.

The inventors have put this model cell 2 into an electric furnace to heat it at 700° C. under the condition that the air is supplied to the reference electrode 12 and one of the following mixed gases (each corresponding to the sensing objective gas) is supplied to the measuring electrode 11. Then, a predetermined voltage is applied between the measuring electrode (cathode) 11 and the reference electrode (anode) 12 via the lead lines 13 and 14 from an external power source 20. The inventors have measured the current-voltage characteristics of the model cell 2 with the voltage sweep speed of 0.5 mV/sec.

### Composition of Tested Sensing Objective Gas

(1) O₂—N₂ mixed gas containing 100 ppm O₂ (hereinafter, referred to as “100 ppm O₂—N₂”)

(2) NO—O₂—N₂ mixed gas containing 500 ppm NO and 100 ppm O₂ (hereinafter, referred to as “500 ppm NO—100 ppm O₂—N₂”)

(3) NO—O₂—N₂ mixed gas containing 1000 ppm NO and 100 ppm O₂ (hereinafter, referred to as “1000 ppm NO—100 ppm O₂-N₂”)

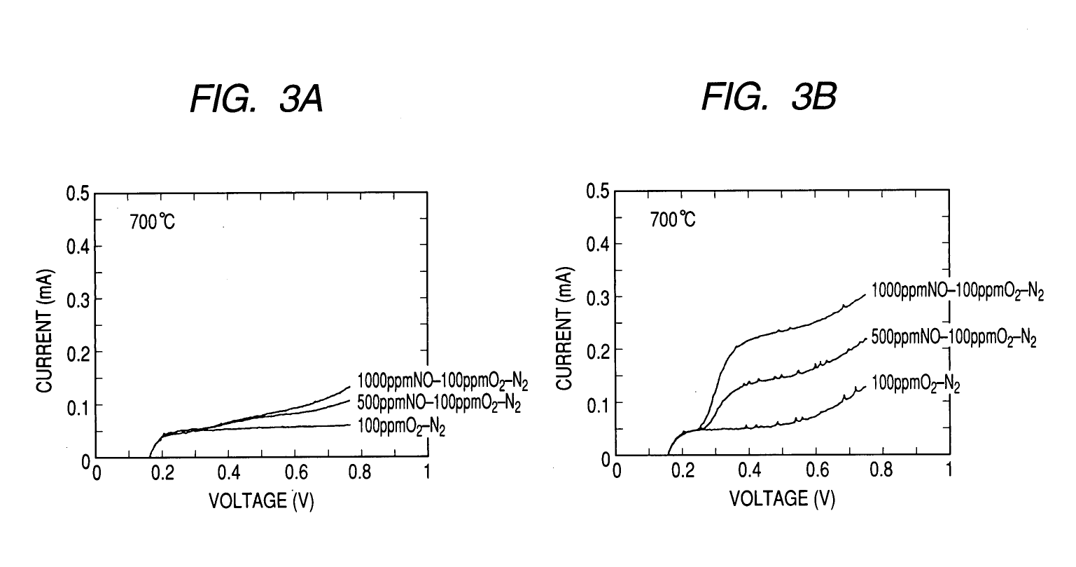

FIG. 3A shows the current-voltage characteristics of a model cell equipped with a NOx sensing cell manufactured by using the sample 1, and FIG. 3B shows the current-voltage characteristics of a model cell equipped with a NOx sensing cell manufactured by using the sample 2. Hereinafter, the model cell equipped with a NOx sensing cell manufactured by using the sample n is referred to as “model cell of sample n”.

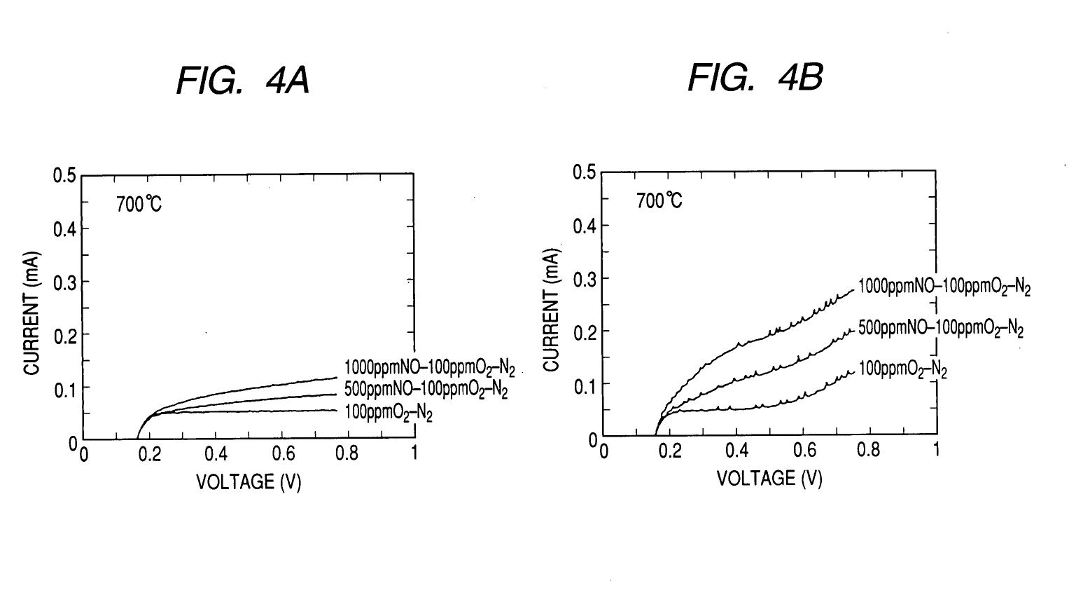

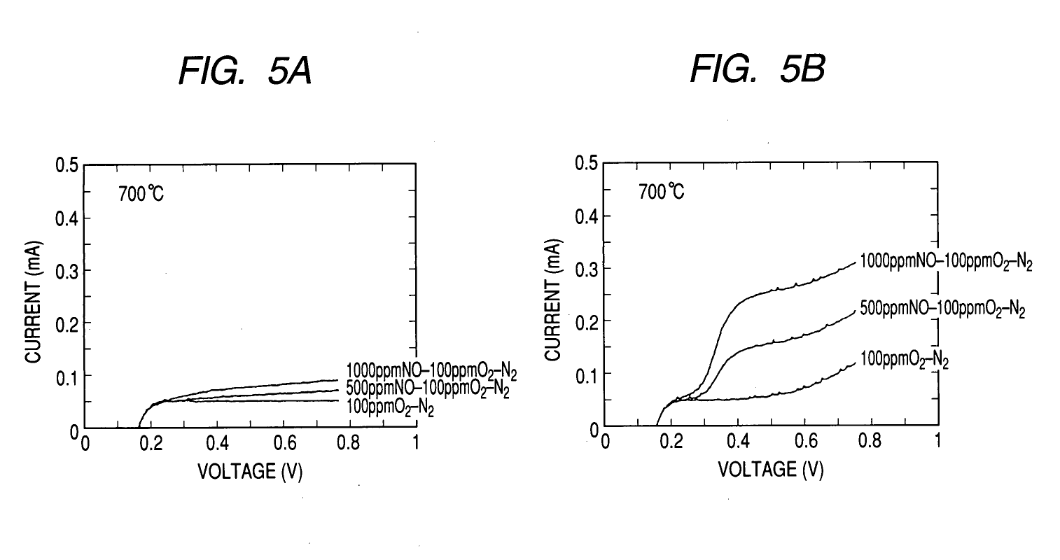

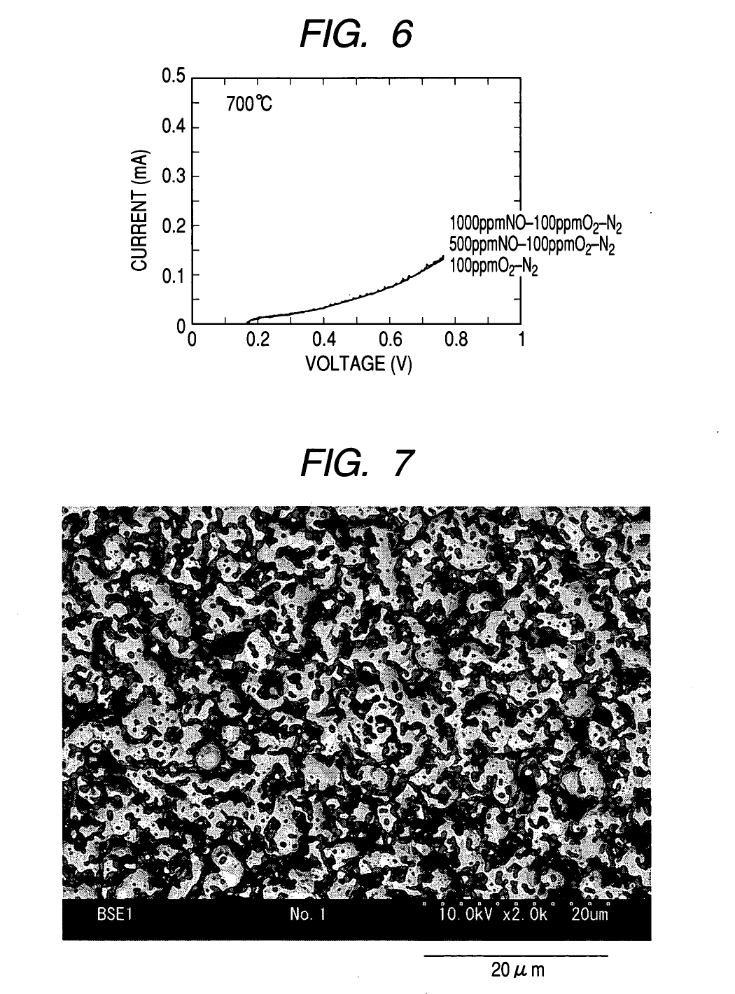

Similarly, FIG. 4A shows the current-voltage characteristics with respect to a model cell of sample 3. FIG. 4B is a graph showing the current-voltage characteristics with respect to a model cell of sample 4. FIG. 5A shows the current-voltage characteristics with respect to a model cell of sample 5. FIG. 5B is a graph showing the current-voltage characteristics with respect to a model cell of sample 6. FIG. 6 shows the current-voltage characteristics with respect to a model cell of sample 7.

The NOx sensing cell constituting each model cell is the one being sintered when manufactured under the condition that The gold (Au) scatters (i.e. the gold deposits on the measuring electrode) as explained above.

As apparent from the comparison between FIG. 3A (sample 1) and FIG. 3B (sample 2), the model cell of sample 2 shows a remarkable increase in the current corresponding to the decomposition of NO as an effect of added cerium oxide. The model cell of sample 2 is different from the model cell of sample 1 in that the cerium oxide is contained. Furthermore, limiting current regions can be confirmed in the current-voltage characteristics shown in FIG. 3B.

Similarly, as apparent from the comparison between FIG. 4A (sample 3) and FIG. 4B (sample 4) as well as from the comparison between FIG. 5A (sample 5) and FIG. 5B (sample 6), addition of the cerium oxide is effective in greatly increasing the current corresponding to the decomposition of NO. Furthermore, limiting current regions can be confirmed in the current-voltage characteristics shown in FIGS. 4B and 5B.

On the other hand, as shown in FIG. 6, the model cell of sample 7 shows no increase in the NO decomposition current and also shows no limiting current region. The sample 7 contains the cerium oxide. However, unlike the samples 2, 4, 6, the sample 7 does not include two or more kinds of platinum group elements.

From this result, it is confirmed that combining two or more kinds of platinum group elements with the cerium oxide (like the samples 2, 4, and 6) is effective in greatly increasing the NO decompose current. Furthermore, the compositions relating to the samples 2, 4, and 6 have demonstrated excellent properties in that they can form the measuring electrode having preferred NO decomposing characteristics even when they are sintered under the condition that the gold (Au) deposits on the measuring electrode. The model cells of samples 2 and 6, respectively containing Rh as the metallic component, have showed clear limiting current regions (FIGS. 3B and 5B), when they are compared with the model cell of sample 4 which contains no Rh (FIG. 4B). From this result, it is desirable that the metallic components include Pt and Rh (e.g. a combination of Pt—Rh or a combination of Pt—Pd—Rh).

### Analysis of Measuring Electrode

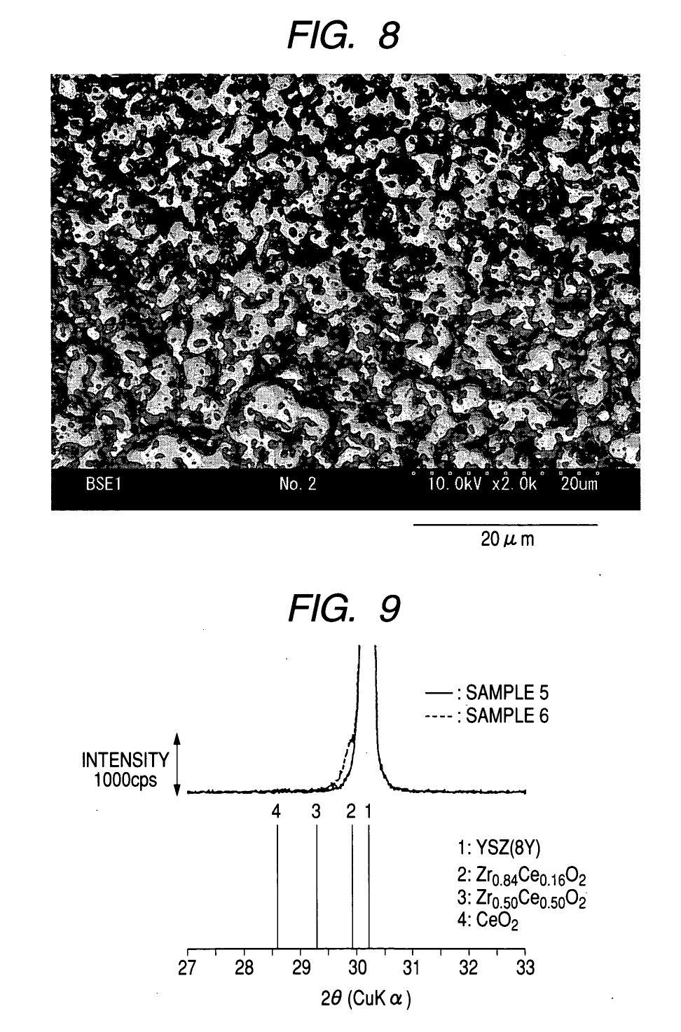

The inventors have performed the SEM-EDX measurement applied on a surface of the measuring electrode having been manufactured by using the compositions of samples 5 and 6. FIG. 7 shows a reflected electron image of the measuring electrode using the sample 5. FIG. 8 shows a reflected electron image of the measuring electrode using the sample 6. As understood from these drawings (i.e. photographic views obtained by a scanning electron microscope), the measuring electrode surfaces have substantially the same micro structure regardless of the addition of the cerium oxide. Furthermore, the EDX measurement has confirmed the presence of Zr and Ce detected from the measuring electrode manufactured by using the sample 6.

Furthermore, the inventors have performed the x-ray diffraction measurement applied to the measuring electrodes manufactured by using the compositions of samples 5 and 6. FIG. 9 shows the obtained x-ray diffraction pattern. From the comparison between the diffraction patterns of the samples 5 and 6, it is confirmed that, according to the sample 6, a peak of YSZ overlapped with that of the solid electrolyte has a shoulder slightly shifted toward the lower angle side. From the comparison with a JCPDS card, it is confirmed that the shifted peak position agrees with the peak position of Zr_{0.84}Ce_{0.16}O₂. Furthermore, the peak position corresponding to ceria is free from a diffraction peak.

From the above result, it is concluded that the cerium oxide contained in the composition of sample 6 is the solid solution containing YSZ obtained through a sintering operation performed at a high temperature exceeding 1400° C. Accordingly, the formed measuring electrode includes the solid solution containing ceria and YSZ.

FIG. 9 shows peak positions respectively corresponding to YSZ(8Y) (═ZrO₂-8 mol % Y₂O₃), Zr_{0.84}Ce_{0.16}O₂, Zr_{0.5}Ce_{0.5}O₂, and CeO₂, in comparison with the −ray diffraction pattern.

### Manufacturing and Evaluation of NOx Sensing Cell

The inventors have manufactured NOx sensing cells by using the measuring electrode forming compositions of samples 8 to 10 according to the above-described method.

TABLE 2

| | Measuring electrode composition | | Reference |
|---|---|---|---|
| Sample | | Cerium | electrode |
| No. | Base material | oxide*1 | composition |
| 8-1 | Pt-25.2% Pd-10.8% Rh-10% YSZ | 0.01 | Pt-10% YSZ |
| 8-2 | | | |
| 9-1 | Pt-25.2% Pd-10.8% Rh-10% YSZ | 0.02 | Pt-10% YSZ |
| 9-2 | | | |
| 10 | Pt-25.2% Pd-10.8% Rh-10% YSZ | 0.1 | Pt-10% YSZ |

*1cerium oxide amount (g) added to the base material of 1 g

The inventors have constructed model cells incorporating the obtained NOx sensing cells and measured the current-voltage characteristics of these model cells.

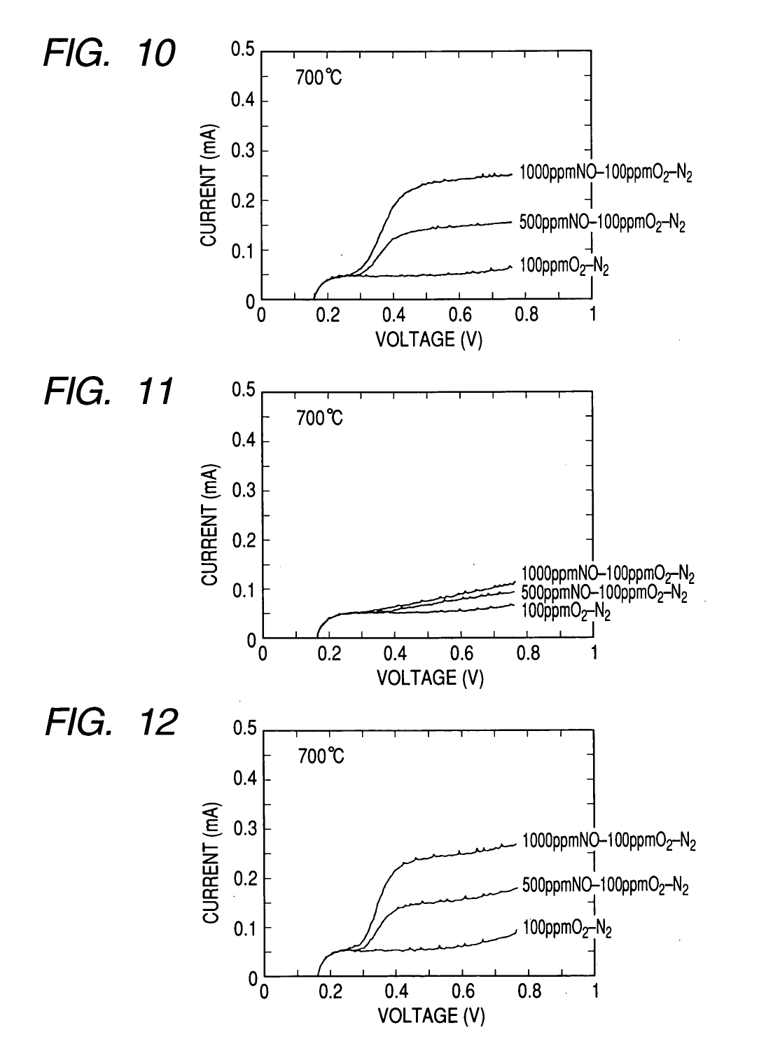

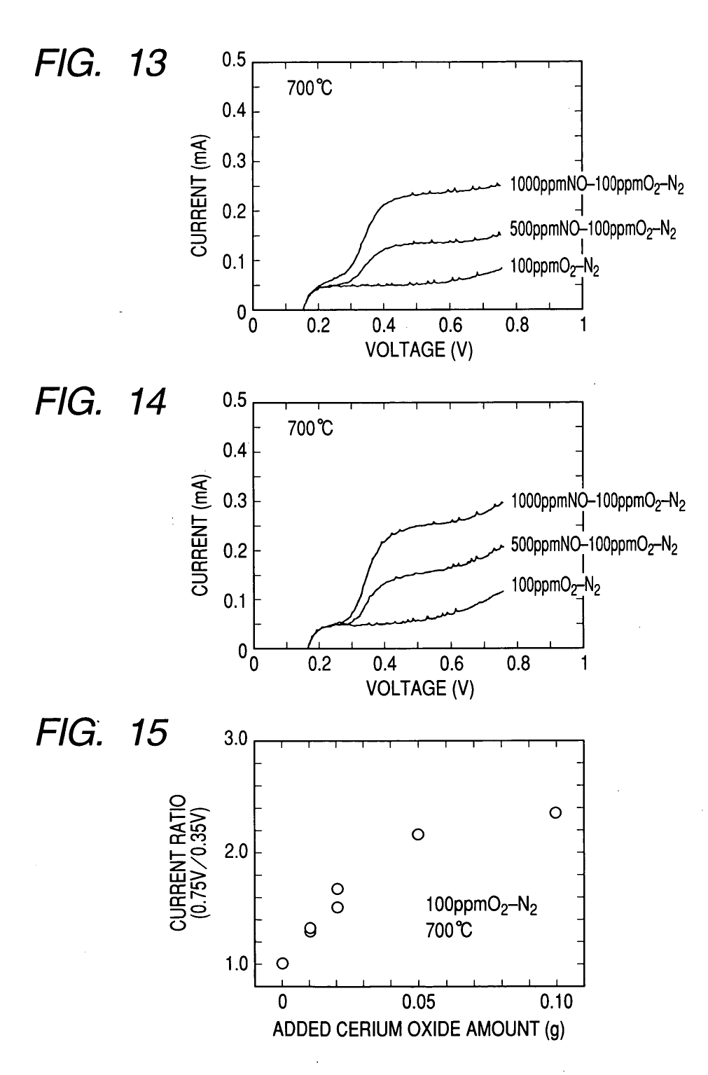

Regarding the samples 8 and 9, the inventors have prepared two identical measuring electrode forming compositions for each sample which are referred to as samples 8-1 and 8-2 and samples 9-1 and 9-2, respectively. The inventors have manufactured NOx sensing cells by using respective compositions, constructed the model cells, and measured the current-voltage characteristics of the model cells. FIGS. 10 to 14 show the obtained current-voltage characteristics of respective model cells.

As understood from these drawings, the model cells of sample 9-1, sample 9-2 (containing cerium oxide by 0.02 g), and sample 10 (containing cerium oxide by 0.1 g) show adequate NO decomposing activity. Furthermore, these model cells show clear limiting current regions in the current-voltage characteristics.

Regarding the samples 8-1 and 8-2 (containing cerium oxide by 0.01 g), the model cell of sample 8-1 shows excellent NOx decomposing activity, compared with the model cell of sample 8-2.

From this result, to improve the NOx decomposing activity under the composition and manufacturing conditions of this embodiment, it is desirable to add approximately 0.01 g or more (e.g, approximately 0.01 to 0.1 g) cerium oxide to the base material (i.e. the constituent component of the measuring electrode other than cerium oxide) of 1 g. To surely obtain excellent effects, it is desirable to add approximately 0.02 g or more cerium oxide to the base material of 1 g.

### NOx Detecting Sensitivity

The inventors have measured the current-voltage characteristics of 25 the model cells of sample 5 (containing no cerium oxide), sample 6 (containing cerium oxide by 0.05 g), sample 8 (containing cerium oxide by 0.01 g), sample 9 (containing cerium oxide by 0.02 g), and sample 10 (containing cerium oxide by 0.1 g) under the condition that the sensing objective gas is 100 ppm O₂—N₂. Based on the measurement results, the inventors have calculated the ratio of the current value at the voltage 0.75V to the current value at the voltage 0.35V. FIG. 15 shows the relationship between the obtained current ratio and the added cerium oxide amount.

In general, the zirconia-ceria solid solution has the tendency of being easily chemically reduced, when it is compared with the zirconia containing no ceria. Accordingly, the ceria-containing measuring electrode tends to release the oxygen from its ceria portion. The released oxygen becomes an oxide ion. When the oxide ions flow across a solid electrolyte, it is detected as a current value. Such releasing of oxygen can be promoted by increasing a voltage applied between the electrodes. The limiting current gradually increases in accordance with addition of the current resulting from the oxygen released from the measuring electrode (i.e. from the zirconia-ceria solid solution). FIG. 15 shows the degree of increasing limiting current. When the ceria amount is large, a great amount of current is produced due to the chemical reduction of the zirconia-ceria solid solution. Such an increase of current will possibly become an offset in the NOx concentration. Accordingly, to enhance the measuring accuracy of the NOx concentration, it is preferable to set the cerium oxide amount to be added (i.e. ceria content) to a smaller value. Although not limited to specific values, under the gas composition and manufacturing conditions of this embodiment, it is desirable to add approximately 0.05 g or less (e.g, approximately 0.01 to 0.05 g) cerium oxide to the base material (i.e. the constituent component of the measuring electrode other than cerium oxide) of 1 g.

The present invention is not limited to the above-described detailed arrangements and accordingly can be modified in various ways.

1. A NOx sensing cell comprising:
a solid electrolyte having oxide ion conductivity, and
a pair of electrodes electrically connected to said solid electrolyte,
wherein a measuring electrode serving as one of said two electrodes
includes an oxide portion and a noble metallic portion,
said oxide portion includes the solid solution of zirconia containing at least ceria, and
said noble metallic portion contains at least two kinds of metallic elements selected from platinum group elements.

2. The NOx sensing cell in accordance with claim 1, wherein said metallic element includes Pt and at least one of Pd and Rh.

3. The NOx sensing cell in accordance with claim 1, wherein an atomic ratio of Zr and Ce contained in said oxide portion satisfies the condition Ce/Zr≦0.5.

4. The NOx sensing cell in accordance with claim 1, wherein said measuring electrode contains said oxide portion by 0.5 to 20 mass %.

5. A NOx sensing device comprising:
a measuring chamber into which a gas to be measured is introduced;
a NOx sensing cell for detecting the concentration of NOx contained in said gas introduced in said measuring chamber; and
an oxygen pump cell for electrochemically removing oxygen out of said measuring chamber,
wherein said NOx sensing cell comprises:
a first solid electrolyte having oxide ion conductivity, a pair of electrodes electrically connected to said first solid electrolyte, wherein a measuring electrode serving as one of said two electrodes includes an oxide portion and a noble metallic portion, said oxide portion includes the solid solution of zirconia containing at least ceria, and said noble metallic portion contains at least two kinds of metallic elements selected from platinum group elements, and
said oxygen pump cell comprises:
a second solid electrolyte for conducting the oxygen from said measuring chamber to the outside of said measuring chamber; and a pair of electrodes electrically integrated with said second solid electrolyte.

6. The NOx sensing device in accordance with claim 5, wherein at least one electrode of said oxygen pump cell contains Au.

7. A method for manufacturing a NOx sensing cell, comprising the steps of:
preparing a measuring electrode forming composition comprising an oxide ceramic forming component containing Zr and Ce and a noble metallic component containing at least two kinds of metallic elements selected from platinum group elements;
putting said measuring electrode forming composition on a surface of a ceramic molded body, said ceramic molded body forming a solid electrolyte having oxide ion conductivity when said ceramic molded body is sintered; and
sintering said ceramic molded body together with said measuring electrode forming composition in the temperature range from 1200° C. to 1700° C.

8. A method for manufacturing a NOx sensing cell, comprising the steps of:
preparing a measuring electrode forming composition comprising an oxide ceramic forming component containing Zr and Ce and a noble metallic component containing at least two kinds of metallic elements selected from platinum group elements;
putting said measuring electrode forming composition on a surface of an oxide ion conductive solid electrolyte having a predetermined shape; and
sintering said oxide ion conductive solid electrolyte together with said measuring electrode forming composition in the temperature range from 1200° C. to 1700° C.
